(19) United States
(12) Patent Application Publication
(10) Pub. No.: US 2006/0071456 A1
(43) Pub. Date: Apr. 6, 2006

(54) Air bag module having a closure device for closing vents in response to full extension of the air bag

(75) Inventors: Jeffrey A. Jenkins, Shelby Township, MI (US); Kurt F. Fischer, Oxford, MI (US); Richard H. Barnes, Lake Orion, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems, Inc.

(21) Appl. No.: 10/949,635

(22) Filed: Sep. 24, 2004

(51) Int. Cl. B60R 21/16

(52) U.S. Cl. 280/728.2

(57) ABSTRACT

A vehicle occupant protection apparatus (10) includes a housing (30). The housing (30) includes a flow opening (70, 98) through which fluid may flow. The vehicle occupant protection apparatus also includes an inflatable occupant protection device (14) that is inflatable from a stored condition to an inflated condition. Structure (18, 20) of the inflatable occupant protection device (14) defines an inflatable volume of the inflatable occupant protection device (14). A closure device (120) is movable relative to the housing (30) from a first position to a second position for restricting fluid flow through the flow opening (70, 98). The structure (18, 20) of the inflatable occupant protection device (14) is attached to the closure device (120). A force resulting from the inflatable occupant protection device (14) reaching full extension moves the closure device (120) from the first position to the second position.

### TECHNICAL FIELD

The present invention relates to a vehicle occupant protection apparatus. More particularly, the present invention relates to an air bag module having a closure device that closes one or more flow openings in response to an air bag reaching an extended condition.

### BACKGROUND OF THE INVENTION

It is known to provide air bag modules with vent openings through which inflation fluid is discharged. When an occupant of a vehicle is positioned in a location such that an air bag will contact the occupant while the air bag is still being inflated, the vent openings enable inflation fluid to be discharged from the air bag module to atmosphere. The discharge of inflation fluid through the vent openings reduces the contact force between the inflating air bag and the occupant.

U.S. patent application Publication No. 2004/0051285 A1, which is assigned to the assignee of the present invention, discloses an air bag module having a support member that includes vent openings through which inflation fluid may flow. Each vent opening of the air bag module has an associated vent member. A tether connects each vent member to an outer panel of the air bag. When the air bag inflates to a predetermined location relative to the support member, the tether pulls the vent member to block inflation fluid flow through the vent opening. When the inflating air bag contacts an occupant, inflation fluid is discharged through the vent openings.

### SUMMARY OF THE INVENTION

The present invention relates to a vehicle occupant protection apparatus comprising a housing that includes a flow opening through which fluid may flow. The vehicle occupant protection device also comprises an inflatable occupant protection device that is inflatable from a stored condition to an inflated condition. Structure of the inflatable occupant protection device defines an inflatable volume of the inflatable occupant protection device. A closure device is movable relative to the housing from a first position to a second position for restricting fluid flow through the flow opening. The structure of the inflatable occupant protection device is attached to the closure device. A force results from the structure of the inflatable occupant protection device reaching a full extension during inflation from the stored condition to the inflated condition. The force acts through the structure of the inflatable occupant protection device that is attached to the closure device and moves the closure device from the first position to the second position.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a perspective view of a portion of a vehicle occupant protection apparatus constructed in accordance with the present invention;

FIG. 2 is a schematic sectional view of the vehicle occupant protection apparatus of FIG. 1 and illustrates vents in an open condition and an air bag in a stored condition;

FIG. 3 is a schematic sectional view of the vehicle occupant protection apparatus of FIG. 1 and illustrates vents in an open condition and an air bag moving from the stored condition toward an extended condition;

FIG. 4 schematically illustrates the vehicle occupant protection apparatus contacting an occupant prior to the air bag reaching the extended condition;

FIG. 5 is a schematic sectional view of the vehicle occupant protection apparatus of FIG. 1 and illustrates the air bag in the extended condition and the vents in a closed condition;

FIG. 6 is a schematic sectional view of a vehicle occupant protection apparatus constructed in accordance with a second embodiment of the present invention and illustrates the vents in an open condition;

FIG. 7 is a schematic sectional view of a vehicle occupant protection apparatus constructed in accordance with a third embodiment of the present invention and illustrates the vents in an open condition;

FIG. 8 is a schematic sectional view of a vehicle occupant protection apparatus constructed in accordance with a fourth embodiment of the present invention and illustrates the vents in an open condition;

FIG. 9 is a schematic sectional view of a vehicle occupant protection apparatus constructed in accordance with a fifth embodiment of the present invention and illustrates the vents in an open condition;

FIG. 10 is a schematic sectional view of a vehicle occupant protection apparatus constructed in accordance with a sixth embodiment of the present invention and illustrates the vents in an open condition;

FIG. 11 is a schematic sectional view of a vehicle occupant protection apparatus constructed in accordance with a seventh embodiment of the present invention and illustrates the vents in an open condition; and

FIG. 12 is a schematic sectional view of a vehicle occupant protection apparatus constructed in accordance with an eighth embodiment of the present invention and illustrates the vents in an open condition.

### DETAILED DESCRIPTION OF THE INVENTION

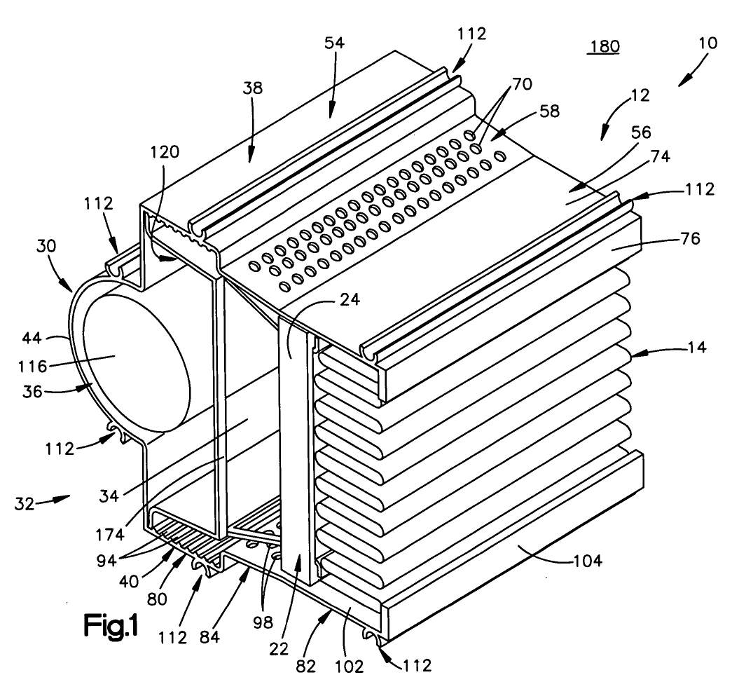

FIGS. 1-5 illustrate a vehicle occupant protection apparatus 10 constructed in accordance with the present invention. The vehicle occupant protection apparatus 10 of FIGS. 1-5 includes an air bag module 12 that includes an inflatable occupant protection device 14. The inflatable occupant protection device 14 of FIGS. 1-5 is an air bag. As an alternative to the air bag, the inflatable occupant protection device 14 may be an inflatable seat belt, an inflatable knee bolster, an inflatable head liner, an inflatable side curtain, a knee bolster operated by an inflatable air bag, or any other type of inflatable occupant protection device.

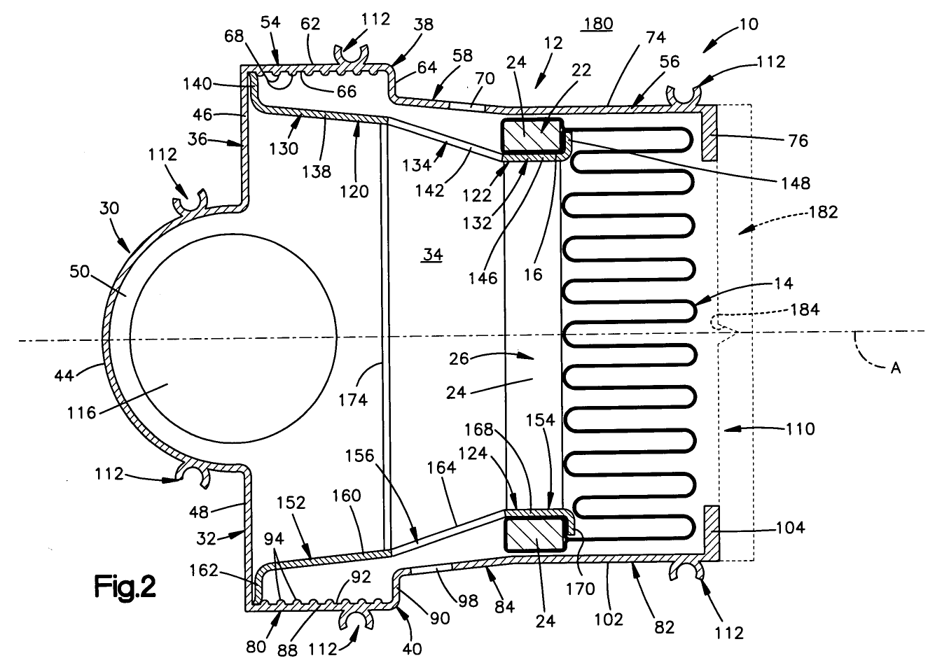

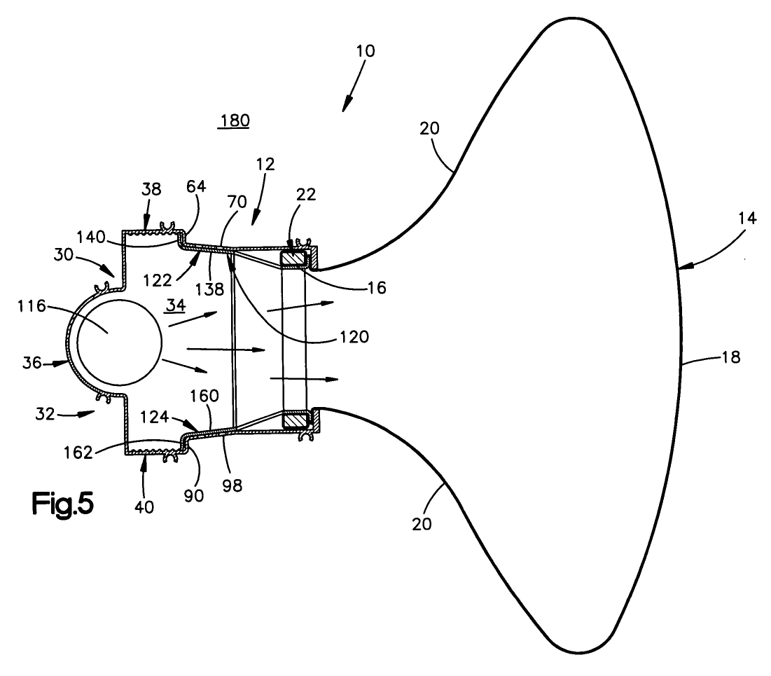

The air bag 14 is inflatable between a stored condition and an inflated condition. FIG. 2 illustrates the air bag 14 in the stored condition. When in the stored condition, the air bag 14 is completely deflated and is packed into a compact configuration. FIG. 5 illustrates the air bag 14 in the inflated condition. The air bag 14 inflates from the stored condition to the inflated condition in response to receiving inflation fluid.

A mouth portion 16 (FIG. 2) of the air bag 14 defines an opening through which inflation fluid flows when passing into the air bag. As shown in FIG. 5, the air bag 14 includes a front panel 18 and side panels 20. The front panel 18 and the side panels may be different portions of a single piece of material or may be separate pieces of material that are sewn together to form the air bag 14. The side panels 20 extend between the mouth portion 16 and the front panel 18. The front panel 18 and the side panels 20 define an inflatable volume of the air bag 14. During inflation from the stored condition to the inflated condition, the front panel 18 and the side panels 20 of the air bag 14 reach a full extension. When the front panel 18 and the side panels 20 reach a full extension, slack is removed from the front panel 18 and the side panels 20 and the front panel and side panels are pulled taut. The front panel 18 and the side panels 20 may reach the full extension prior to the air bag reaching the inflated condition with pressure within the air bag at or above a desire pressure. When the front panel 18 and the side panels 20 reach the full extension, the air bag is in a fully extended condition.

A bag retainer 22 is associated with the air bag 14. The bag retainer 22 is rectangular in shape includes four sides 24. One of the sides 24 of the bag retainer 22 is shown in FIG. 1. The other three sides 24 of the bag retainer are shown in FIG. 2. A central opening 26 (FIG. 2), which is rectangular in shape, extends through the bag retainer 22.

The air bag 14 is secured to the bag retainer 22. The mouth portion 16 of the air bag 14 loops around the sides 24 of the bag retainer 22 and back upon itself. The resulting overlapped parts of the mouth portion 16 of the air bag 14 are sewn together to secure the air bag to the bag retainer 22.

The air bag module 12 includes a module housing 30. The module housing 30 includes a main body portion 32 and opposite side wall portions (not shown), which close laterally opposite sides of the main body portion. For ease of illustration, only the main body portion 32 of the module housing 30 is shown in FIGS. 1-5. A chamber 34 is located within the module housing 30.

The main body portion 32 of the module housing 30 includes an end wall 36 and opposite upper and lower walls 38 and 40, respectively. As shown in FIG. 2, the end wall 36 includes an arcuate central portion 44 that separates coplanar upper and lower portions 46 and 48, respectively. The central portion 44 of the end wall 36 defines a recessed portion 50 of the chamber 34 and extends away from the upper and lower portions 46 and 48 along a central axis A of the module housing 30. The upper and lower portions 46 and 48 of the end wall 36 extend perpendicular to axis A, as shown in FIG. 2.

As shown in FIG. 2, the upper wall 38 of the main body portion 32 of the module housing 30 extends generally away from the upper portion 46 of the end wall 36 in a direction generally parallel to axis A and opposite to the direction in which the central portion 44 of the end wall extends. The upper wall 38 includes first and second end portions 54 and 56, respectively, and central portion 58. The first end portion 54 of the upper wall 38 includes an axial portion 62 and a radial portion 64. The axial portion 62 of the first end portion 54 extends parallel to axis A, as shown in FIG. 2, from the upper portion 46 of the end wall 36 to the radial portion 64. The radial portion 64 of the first end portion 54 extends toward axis A from the axial portion 62 and is generally perpendicular to both axis A and axial portion 62. An interior surface 66 of the axial portion 62 of the first end portion 54 includes a plurality of ridges 68. The ridges 68 extend in a direction perpendicular to axis A and along the axial portion 62 into and out of the plane of the paper, as viewed in FIG. 2.

As shown in FIG. 2, the central portion 58 of the upper wall 38 is planar and extends away from the first end portion 54 at a predetermined angle relative to axis A. For example, the central portion 58 of FIG. 2 is oriented at an angle of approximately ten degrees relative to axis A. Thus, the greater the distance along the central portion 58 from the first end portion 54, the smaller the distance between the central portion 58 and axis A. As is shown in FIG. 1, multiple flow openings 70 extend through the central portion 58 of the upper wall 38.

As shown in FIG. 2, the second end portion 56 of the upper wall 38 includes an axial portion 74 and a radial portion 76. The axial portion 74 extends outwardly of the central portion 58 in a direction opposite the first end portion 54 and parallel to axis A. The radial portion 76 of the upper wall 38 extends generally perpendicular to and inwardly from an end of the axial portion 74.

The lower wall 40 of the main body portion 32 is a mirror image of the upper wall 38. The lower wall 40 of the main body portion 32 of the module housing 30 extends generally away from the lower portion 48 of the end wall 36 in a direction generally parallel to axis A and opposite to the direction in which the central portion 44 of the end wall extends. As shown in FIG. 2, the lower wall 40 includes first and second end portions 80 and 82, respectively, and a central portion 84. The first end portion 80 of the lower wall 40 includes an axial portion 88 and a radial portion 90. The axial portion 88 of the first end portion 80 extends parallel to axis A, as shown in FIG. 2, from the lower portion 48 of the end wall 36 to the radial portion 90. The radial portion 90 of the first end portion 80 extends from the axial portion 88 toward axis A and is generally perpendicular to both axis A and axial portion 88. An interior surface 92 of the axial portion 88 of the first end portion 80 includes a plurality of ridges 94. The ridges 94 extend in a direction perpendicular to axis A and along the axial portion 88 into and out of the plane of the paper, as viewed in FIG. 2.

As shown in FIG. 2, the central portion 84 of the lower wall 40 is planar and extends away from the first end portion 80 at an angle relative to axis A. For example, the central portion 84 of FIG. 2 is oriented at an angle of approximately ten degrees relative to axis A. Thus, the greater the distance along the central portion 84 from the first end portion 80, the smaller the distance between the central portion 84 and axis A. As is shown in FIG. 1, multiple flow openings 98 extend through the central portion 84 of the lower wall 40.

As shown in FIG. 2, the second end portion 82 of the lower wall 40 includes an axial portion 102 and a radial portion 104. The axial portion 102 extends outwardly of the central portion 84 in a direction opposite the first end portion 80 and parallel to axis A. The radial portion 104 extends generally perpendicular to and inwardly from an end of the axial portion 102.

A deployment opening 110 (FIG. 2) is defined vertically between the radial portions 76 and 104 of the upper and lower walls 38 and 40, respectively, of the module housing 30. A horizontal extent of the deployment opening 110 is defined between side wall portions (not shown) of the module housing 30. The air bag 14, upon receiving inflation fluid, deploys from the module housing 30 through the deployment opening. 110.

The main body portion 32 of the module housing 30 also includes a plurality of screw channels 112. FIGS. 1-5 illustrate two screw channels 112 on the upper wall 38, two screw channels 112 on the lower wall 40, and two screw channels 112 on the central portion 44 of the end wall 36. The screw channels 112 are adapted to receive fasteners (not shown) for attaching the side wall portions of the module housing 30 to the main body portion 32.

The air bag module 12 also includes an inflator 116 that when actuated provides inflation fluid. The inflator 116 is shown schematically in FIGS. 1-5. The inflator 116 may comprise a quantity of ignitable gas-generating material, a quantity of stored gas under pressure, a combustible mixture of gases, or a quantity of stored gas together with pyrotechnic material for heating the stored gas.

The inflator 116 is located in the chamber 34 of the module housing 30. A portion of the inflator 116 is located in the recessed portion 50 of the chamber 34. Fasteners (not shown) fix the inflator 116 relative to the module housing 30. The fasteners may extend outwardly of the inflator 116 and through the side wall portions of the module housing 30. Nuts (not shown) associated with the fasteners may be used for fixing the inflator 116 to the side wall portions of the module housing 30.

The air bag module 12 also includes a closure device 120. As shown in FIG. 2, the closure device 120 includes upper and lower closure members 122 and 124, respectively. The upper closure member 122 includes opposite first and second end portions 130 and 132, respectively, and a central portion 134. The first end portion 130 of the upper closure member 122 includes a wall portion 138 and a flange portion 140. The wall portion 138 of the upper closure member 122 is planar and extends at the same predetermined angle relative to axis A as the central portion 58 of the upper wall 38 of the main body portion 32 of the module housing 30. The flange portion 140 of the first end portion 130 of the upper closure member 122 extends outwardly, relative to axis A, from an end of the wall portion 138.

The central portion 134 of the upper closure member 122 is planar and extends away from of the wall portion 138 of the first end portion 130 at an angle relative to axis A that is greater than the predetermined angle of the wall portion of the first end portion of the upper closure member. For example, in FIG. 2, the wall portion 138 is oriented at an angle of approximately ten degrees relative to axis A and the central portion 134 is oriented at an angle of approximately twenty degrees relative to axis A. Thus, the greater the distance along the central portion 134 from the first end portion 130, the smaller the distance between the central portion 134 and axis A. Multiple flow openings, one of which is shown in FIG. 2 at 142, extend through the central portion 134 of the upper closure member 122.

The second end portion 132 of the upper closure member 122 also includes a wall portion 146 and a flange portion 148. The wall portion 146 of the second end portion 132 is located on a side of the central portion 134 opposite the first end portion 130 of the upper closure member 122. The wall portion 146 extends away from the central portion 134 in a direction parallel to axis A. The flange portion 148 of the second end portion 132 of the upper closure member 122 extends outwardly, relative to axis A, from an end of the wall portion 146 opposite the central portion 134. Thus, as is shown in FIG. 2, the flange portions 140 and 148 form opposite ends of the upper closure member 122.

The lower closure member 124 is a mirror image of the upper closure member 122. As shown in FIG. 2, the lower closure member 124 also includes opposite first and second end portions 152 and 154, respectively, and a central portion 156. The first end portion 152 of the lower closure member 124 includes a wall portion 160 and a flange portion 162. The wall portion 160 of the lower closure member 124 is planar and extends at the same predetermined angle relative to axis A as the central portion 84 of the lower wall 40 of the main body portion 32 of the module housing 30. The flange portion 162 of the first end portion 152 of the lower closure member 124 extends outwardly, relative to axis A, from an end of the wall portion 160.

The central portion 156 of the lower closure member 124 is planar and extends away from the first end portion 152 at an angle relative to axis A that is greater than the predetermined angle of the wall portion 160 of the first end portion 152 of the lower closure member. For example, in FIG. 2, the wall portion 160 is oriented at an angle of approximately ten degrees relative to axis A and the central portion 156 is oriented at an angle of approximately twenty degrees relative to axis A. Thus, the greater the distance along the central portion 156 from the first end portion 152, the smaller the distance between the central portion 156 and axis A. Multiple flow openings, one of which is shown in FIG. 2 at 164, extend through the central portion 156 of the lower closure member 124.

The second end portion 154 of the lower closure member 124 also includes a wall portion 168 and a flange portion 170. The wall portion 168 of the second end portion 154 is located on a side of the central portion 156 opposite the first end portion 152 of the lower closure member 124. The wall portion 168 extends away from the central portion 134 in a direction parallel to axis A. The flange portion 170 of the second end portion 154 of the lower closure member 124 extends outwardly, relative to axis A, from an end of the wall portion 168 opposite the central portion 134. Thus, as is shown in FIG. 2, the flange portions 162 and 170 form opposite ends of the lower closure member 124.

Two support beams connect the upper and lower closure members 122 and 124 of the closure device 120. One of the support beams is shown at 174 in FIGS. 1 and 2. The support beams 174 of the closure device 120 extend from the wall portion 138 of the first end portion 130 of the upper closure member 122 to the wall portion 160 of the first end portion 152 of the lower closure member 124. As shown in FIG. 2, the support beam 174 is fixed to the wall portion 138 of the first end portion 130 of the upper closure member 122 at a location adjacent the central portion 134. The support beam 174 is fixed to the wall portion 160 of the first end portion 152 of the lower closure member 124 at a location adjacent the central portion 156. The support beams 174 fix the upper and lower closure members 122 and 124 for movement with one another.

The closure device 120 is sized to be received in the chamber 34 of the module housing 30. A distance that is approximately equal to the distance between the interior surfaces 66 and 92 of the axial portions 62 and 88 of the upper and lower walls 38 and 40, respectively, of the module housing 30 separates the ends of the flange portions 140 and 162 of the upper and lower closure members 122 and 124, respectively. Thus, when the closure device 120 is positioned in the chamber 34 of the module housing 30, the flange portions 140 and 162 engage the ridges 66 and 94 located on the interior surfaces 66 and 92 of the axial portions 62 and 88. Similarly, a distance that is approximately equal to the distance between the central portions 58 and 84 of the upper and lower walls 38 and 40, respectively, of the module housing 30 separates the wall portions 138 and 160 of the upper and lower closure members 122 and 124. Also, a distance between ends of the flange portions 148 and 170 of the upper and lower closure members 122 and 124 is less than a distance between the axial portions 74 and 102 of the upper and lower walls 38 and 40 of the module housing 30.

The closure device 120 is formed from a resilient -metal. A force may be applied to the first end portions 130 and 152 of the upper and lower closure members 122 and 124 to flex the first end portions inwardly, toward axis A as shown in FIG. 2, from the positions illustrated in FIG. 2. When the force is removed, the first end portions 130 and 152 return to the positions illustrated in FIG. 2. Likewise, a force may be applied to the second end portions 132 and 154 of the upper and lower closure members 122 and 124 to flex the second end portions 132 and 154 inwardly, toward axis A as shown in FIG. 2, from the positions illustrated in FIG. 2. When the force is released, the second end portions 132 and 154 return to the positions illustrated in FIG. 2.

To assemble the apparatus 10 illustrated in FIGS. 1-5, the mouth portion 16 of the air bag 14 is looped around the sides 24 of the bag retainer 22 and then is overlapped back upon itself. The overlapping portions of the mouth portion 16 are sewn together to fix the mouth portion of the air bag 14 to the bag retainer 22.

The second end portions 132 and 154 of the upper and lower closure members 122 and 124 of the closure device 120 are positioned adjacent opposite sides 24 of the bag retainer 22. A force is applied to the second end portions 132 and 154 of the closure device 120 to flex the flange portions 148 and 170 radially inwardly toward one another. While the flange portions 148 and 170 are flexed radially inwardly, the bag retainer 22 is moved relative to the closure device 120 so that the second end portions 132 and 154 of the upper and lower closure members 122 and 124 move through the central opening 26 of the bag retainer. The second end portions 132 and 154 of the upper and lower closure members 122 and 124 then are released. When released, the second end portions 132 and 154 of the upper and lower closure members 122 and 124, respectively, engage the opposite sides 24 of the bag retainer 22 to secure the bag retainer to the closure device 120. As shown in FIG. 2, when the bag retainer 22 is secured to the closure device 120, a side 24 of the bag retainer 22 is positioned adjacent both the wall portion 146 and the flange portion 148 of the second end portion 132 of the upper closure member 122. Another side 24 of the bag retainer 22 is positioned adjacent both the wall portion 168 and the flange portion 170 of the second end portion 154 of the lower closure member 124.

After the bag retainer 22 is attached to the closure device 120, the closure device, along with the attached bag retainer 22 and air bag 14, is positioned within the chamber 34 of the module housing 30. To position the closure device 120 within the chamber 34 of the module housing 30, a force is applied to the first end portions 130 and 152 of the upper and lower closure members 122 and 124 to flex the flange portions 140 and 162 radially inwardly toward one another. While the flange portions 140 and 162 of the first end portions 130 and 152 are flexed radially inwardly, the closure device 120 is slid into the main body portion 32 of the module housing 30 so that the flange portions 140 and 162 are located adjacent the upper and lower portions 46 and 48, respectively, of the end wall 36. The force is then removed from the first end portions 130 and 152 of the closure device 120. The resilience of the closure device moves the flange portions 140 and 162 into engagement with the interior surfaces 66 and 92, respectively, of the wall portions 62 and 88 of the upper and lower walls 38 and 40 of the module housing 30, as is shown in FIG. 2.

One side wall portion (not shown) of the module housing 30 is positioned relative to the main body portion 32 of the module housing to close one side of the main body portion. A first end of the inflator 116 is secured to the side wall portion. The other side wall portion (not shown) is then positioned relative to the main body portion 32 to close the other side of the main body portion. The second end of the inflator 116 is secured to the other side wall portion of the module housing 30. Fasteners (not shown) that extend through the screw channels 112 of the main body portion 32 secure the side wall portions to the main body portion.

When the closure device 120 is in the position shown in FIG. 2 with the flange portions 140 and 162 located adjacent the upper and lower portions 46 and 48, respectively, of the end wall 36 of the module housing 30, the closure device 120 is in a first position relative to the module housing 30. When the closure device 120 is in the first position relative to the module housing 30, the flow openings 142 and 164 in the central portions 134 and 156 of the upper and lower closure member 122 and 124, respectively, are aligned with the flow openings 70 and 98 of the central portions 58 and 84 of the upper and lower walls 38 and 40, respectively, of the main body portion 32 of the module housing 30. As a result, the portion of the chamber 34 that is located within the closure device 120 is in fluid communication with atmosphere, located outside the module housing 30 and indicated at 180 in FIGS. 1-5, via the aligned flow openings 70 and 142 and 98 and 164. When the closure device 120 is in the first position, the ridges 68 and 94 that are located on the interior surfaces 66 and 92, respectively, of the axial portions 62 and 88 of the upper and lower walls 38 and 40 of the module housing 30 act to resist relative movement between the closure device 120 and the module housing.

When the air bag module 12 is installed in a vehicle, a deployment door 182, illustrated schematically in FIG. 2, covers the deployment opening 110 of the module housing 30. The deployment door 182 provides an initial resistance to inflation of the air bag 14. A tear seam 184 of the deployment door 182 is designed to rupture to open the deployment door when subjected to a predetermined force from the air bag 14.

When the inflator 116 of the air bag module 12 is actuated, inflation fluid is directed into the chamber 34 from the inflator 116. The pressure within the chamber 34 begins to increase, and the air bag 14 inflates into a position pressing against the deployment door 182. As a result of the increased pressure within the chamber 34, inflation fluid may begin to flow out of the chamber 34 and to atmosphere 180 through the flow openings 142 and 164 in the closure device 120 and the flow openings 70 and 98 in the module housing 30. When the air bag 14 presses against the deployment door 182 with the predetermined force, the tear seam 184 of the deployment door 182 ruptures and the deployment door opens to enable deployment of the air bag 14.

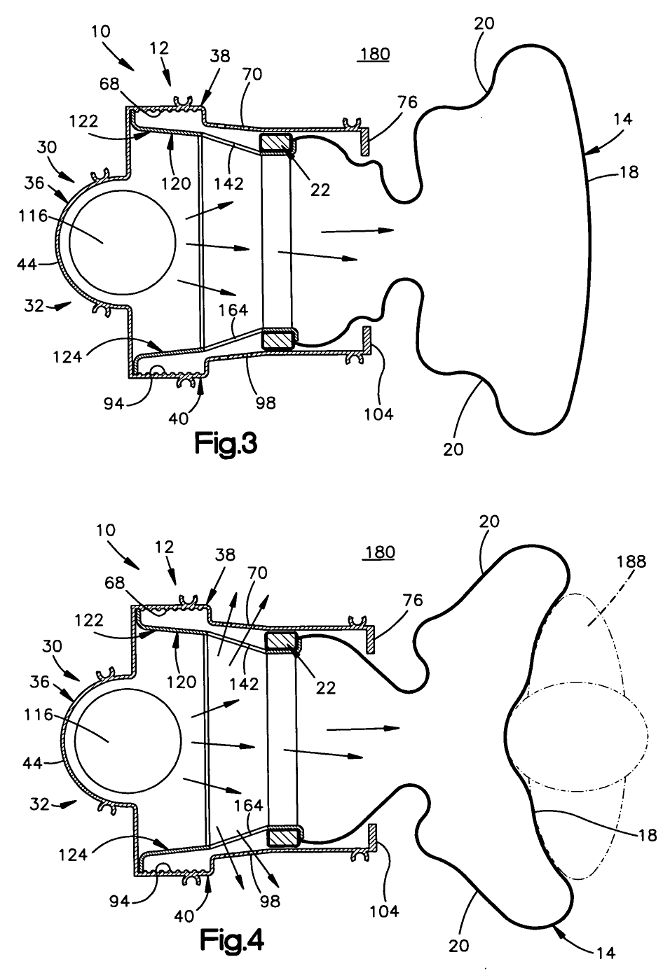

When the deployment door 182 opens, the air bag 14 begins to expand through the deployment opening 110 of the module housing 30. FIG. 3 illustrates the air bag 14 moving from the stored condition toward the inflated condition. The expansion of the air bag 14 through the deployment opening 110 results in a decrease in the pressure within the chamber 34 and within the air bag. As a result of the decreased pressure within the chamber 34 and the air bag 14, air begins to aspirate from atmosphere 180 through the flow openings 70 and 98 of the module housing 30 and the flow openings 142 and 164 of the closure device 120 and into the chamber 34.

As air is aspirated from atmosphere 180 into the chamber 34, the inflator 116 continues to provide inflation fluid. The combination of inflation fluid from the inflator 116 and aspirated air enters the air bag 14, moves the air bag toward the inflated condition, and begins to increase the pressure within the air bag.

During inflation of the air bag 14 toward the inflated condition, the air bag 14 reaches the extended condition in which the front panel 18 and the side panels 20 of the air bag reach full extension. Generally, the air bag 14 reaches the extended condition prior to becoming fully inflated. The shape of the air bag 14 when the air bag is in the extended condition may be the same as the shape of the air bag when in the inflated condition or may differ from the shape of the air bag when in the inflated condition. An air bag 14 reaches the inflated condition when the air bag is in the extended condition and when pressure within the air bag reaches a desired pressure.

Prior to the air bag 14 reaching the extended condition, the closure device 120 remains in the first position relative to the module housing 30. The ridges 68 and 94 of the module housing 30 provide sufficient resistance to prevent movement of the closure device 120 away from the first position. As a result, when the closure device 120 is in the first position, illustrated in FIGS. 1-4, vents formed by the flow openings 142 and 164 of the closure device 120 and the flow openings 70 and 98 of the module housing 30 remain in the fully open condition.

If, prior to the air bag 14 reaching the extended condition, the expanding air bag 14 engages an occupant 188, as shown in FIG. 4, inflation fluid may exit the chamber 34 through the vents formed by the flow openings 142 and 164 of the closure device 120 and the flow openings 70 and 98 of the module housing 30, as is illustrated in FIG. 4. By enabling the flow of inflation fluid away from the chamber 34 and the air bag 14 through the vents, the pressure within the air bag 14 may be controlled.

With reference to FIG. 4, when the air bag 14 engages an occupant 188, continued extension of the air bag 14 is prevented. The inflation fluid provided by the inflator 116, and also any aspirated air, continues to increase the air pressure within the air bag 14 and within the chamber 34 of the module housing 30. When the air pressure within the air bag 14 and the chamber 34 increases above atmospheric air pressure, inflation fluid may exit the chamber 34 through the flow openings 70 and 98 to limit the pressure within the air bag 14. The force that the air bag 14 imparts to the occupant 188 is related to the pressure within the air bag. Thus, by limiting the pressure within the air bag 14, the force that is imparted to the occupant 188 from the air bag 14 is reduced.

Preferably, the air bag 14 reaches the extended condition and is fully inflated prior to any engagement with the occupant 188. FIG. 5 illustrates the air bag 14 in the extended and fully inflated condition. When the air bag 14 reaches the extended condition, a force acts through the side panels 20 of the air bag 14 on the bag retainer 22. The force pulls the air bag retainer 22 toward the deployment opening 110 of the module housing 30. The force results from the front panel 18 and the side panels 20 of the air bag 14 being pulled taut.

Since the air bag retainer 22 is secured to the closure device 120, the force is transferred to the closure device 120. The force acts to pull the closure device 120 away from the first position relative to the module housing 30, illustrated in FIGS. 2 and 3, and into a second position relative to the module housing, illustrated in FIG. 5. Since the force that results from the air bag 14 reaching the extended condition is greater than the resistance provided by the ridges 68 and 94 of the module housing 30, the closure device 120 moves over the ridges 68 and 94 as the closure device moves from the first position to the second position.

As is illustrated in FIG. 5, when the closure device 120 is in the second position relative to the module housing 30, the flange portion 140 of the upper closure member 122 engages the radial portion 64 of the upper wall 38 of the module housing 30. Likewise, the flange portion 162 of the lower closure member 124 engages the radial portion 90 of the lower wall 40 of the module housing. When the flange portions 140 and 162 of the closure device 120 engage the radial portions 64 and 90, respectively, the wall portions 138 and 160 of the upper and lower closure members 122 and 124 extend over the flow openings 70 and 98 in the upper and lower walls 38 and 40, respectively, of the module housing 30. Thus, when the closure device 120 is in the second position relative to the module housing 30, the flow openings 70 and 98 are closed completely and air is prevented from exiting the chamber 34 through the flow openings.

When an occupant engages the extended and fully inflated air bag 14, the front panel 18 and the side panels 20 of the air bag 14 flex to help absorb the impact of the occupant. A force may be transferred from the air bag 14 to the bag retainer 22 that tends to urge the bag retainer back, leftward, as viewed in FIG. 5, toward the end wall 36 of the module housing 30. Since the bag retainer 22 is secured to the closure device 120, this force is transferred to the closure device 120 and tends to urge the closure device away from the second position and back toward the first position. The ridges 68 and 94 of the module housing 30 act on the flange portions 140 and 162 of the closure device 120 to resist the movement of the closure device back toward the first position. The resistance provided by the ridges 68 and 94 is sufficient to prevent movement of the closure device 120 as a result of the engagement of the occupant with the air bag 14. As a result, the flow openings 70 and 98 remain closed and inflation fluid is prevented from exiting the chamber 34 through the flow openings.

A key feature of the air bag module 12 is that the flow openings 70 and 98 in the module housing 30 remain in the fully open condition until the air bag 14 reaches the extended condition. Many conventional air bag modules include mechanisms that begin to close vents prior to the air bag becoming fully extended. As the air bag nears the extended condition, the vents near the fully closed condition. As a result, if the air bag contacts an occupant when the air bag is near its extended condition, the vents of the air bag module are near the fully closed condition and gas flow through the vents is restricted. By remaining in the fully open condition until the air bag reaches the extended condition, the protection apparatus 10 of the present invention helps to control the force of engagement between the air bag 14 and an occupant at all times prior to the air bag reaching the extended condition.

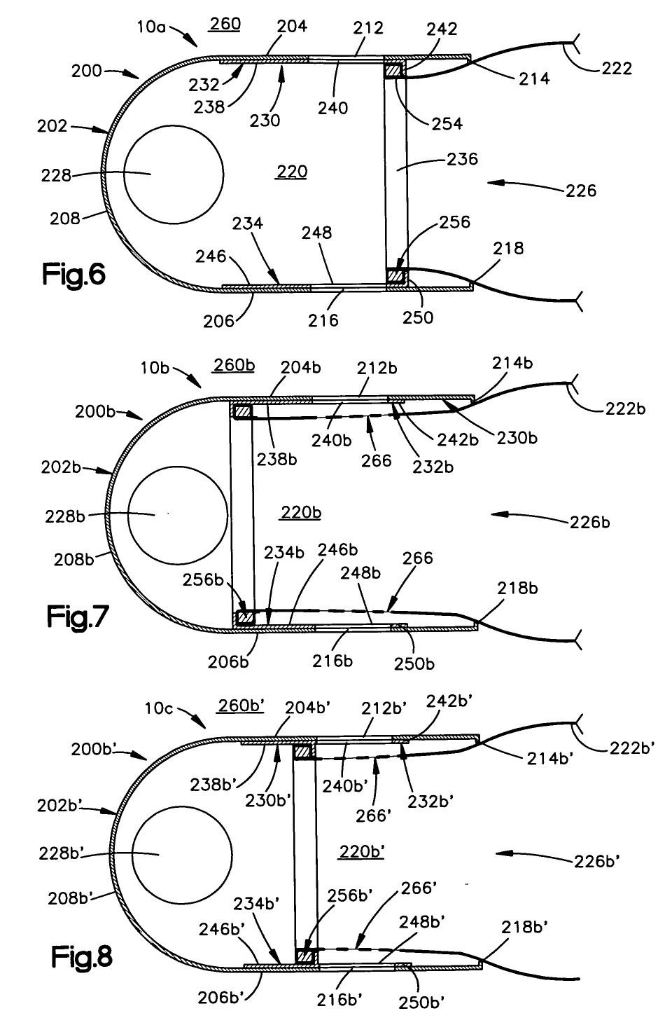

FIGS. 6-12 illustrate additional embodiments of a vehicle occupant protection apparatus constructed in accordance with the present invention. Each vehicle occupant protection apparatus illustrated in FIGS. 6-12 operates in a manner similar to the vehicle occupant protection apparatus 10 of FIGS. 1-5. Therefore, for brevity of the present application, the embodiments of FIGS. 6-12 are only illustrated with the vents in an open condition. As with the vehicle occupant protection apparatus 10 of FIGS. 1-5, the closure device in each vehicle occupant protection apparatus of FIGS. 6-12, moves from a first position in which the vents are in the open condition to a second position in which the vents are in a closed condition in response to the air bag reaching the extended condition.

The apparatus 10a of FIG. 6 includes a module housing 200 having a main body portion 202 and opposite side wall portions (not shown). The main body portion 202 includes upper and lower walls 204 and 206, respectively, and a curved end portion 208.

The curved end portion 208 has a semi-circular cross-sectional shape. The upper wall 204 includes a centrally located elongated flow opening 212. The upper wall 204 terminates at an end opposite the curved end portion 208 with a flange 214 that extends toward the lower wall 206. The lower wall 206 also includes a centrally located elongated flow opening 216. The lower wall 206 terminates at an end opposite the curved end portion 208 with a flange 218 that extends toward the upper wall 204.

The module housing 200 includes an interior chamber 220 in which an air bag 222 is stored when in the deflated and stored condition. A deployment opening 226 is defined vertically between the flanges 214 and 218 of the upper and lower walls 204 and 206, respectively, and is defined horizontally between the opposite side wall portions of the module housing 200. The air bag 222, in response to receiving inflation fluid, inflates through the deployment opening 226.

An inflator 228 that is actuatable for providing inflation fluid is located within the chamber 220 of the module housing 200. The inflator 228 is located in a curved portion of the chamber 220 defined by the curved end portion 208 of the main body portion 202. The inflator 228 may be secured relative to the curved end portion 208 in any known manner. For example, the inflator 228 may be secured between the opposite side wall portions of the module housing 200.

The closure device 230 of the apparatus 10a of FIG. 6 includes upper and lower closure members 232 and 234, respectively. Two support members, one of which is shown at 236, are interposed between the upper and lower closure members 232 and 234 for securing the upper and lower closure members together.

The upper closure member 232 of the closure device 230 includes an elongated wall portion 238, a central flow opening 240 and an end portion 242. The elongated wall portion 238 is generally planar and has dimensions that are larger than the dimensions of the elongated flow opening 212 of the upper wall 204 of the module housing 200. The central flow opening 240 has dimensions that are substantially equal to the dimensions of the elongated flow opening 212 of the upper wall 204 of the module housing 200. The end portion 242 of the upper closure member 232 includes a flange that extends toward the lower closure member 234.

The lower closure member 234 of the closure device 230 includes an elongated wall portion 246, a central flow opening 248, and an end portion 250. The elongated wall portion 246 is generally planar and has dimensions that are larger than the dimensions of the elongated flow opening 216 of the lower wall 206 of the module housing 200. The central flow opening 248 has dimensions that are substantially equal to the dimensions of the elongated flow opening 216 of the lower wall 206 of the module housing 200. The end portion 250 of the lower closure member 234 includes a flange that extends toward the upper closure member 232.

The mouth portion 254 of the air bag 222 is secured to a bag retainer 256. The bag retainer 256 is secured to the flanges of the end portions 242 and 250 of the upper and lower closure members 232 and 234. The mouth portion 254 defines an opening that extends through the bag retainer 256 and into the air bag 222.

FIG. 6 illustrates the closure device 230 in the first position relative to the module housing 200. When the closure device 230 is in the first position, the flow openings 240 and 248 in the closure device 230 are aligned with the flow openings 212 and 216 in the module housing 200, and the chamber 220 of the module housing 200 is in fluid communication with atmosphere 260. Friction acts between the upper and lower closure members 232 and 234 and the upper and lower walls 204 and 206 of the module housing 200 to maintain the closure device 230 in the first position relative to the module housing 200.

When the inflator 228 is actuated and the air bag 222 inflates into the extended condition, a force acts through side panels of the air bag 222. The force is transferred to the bag retainer 256 and to the closure device 230 for moving the closure device from the first position relative to the module housing 200 to a second position relative to the module housing. In the second position of the closure device 230 relative to the module housing 200, the end portions 242 and 250 of the upper and lower closure members 232 and 234 engage the flanges 214 and 218, respectively, of the upper and lower walls 204 and 206 of the module housing. Also, in the second position, the elongated wall portions 238 and 246 of the upper and lower closure members 232 and 234 close the flow openings 212 and 216 in the upper and lower walls 204 and 206 of the module housing 200 to prevent gas flow from the chamber 220 through the flow openings.

The apparatus 10b of FIG. 7 is similar to the apparatus 10a of FIG. 6. Therefore, portions of the apparatus 10b in FIG. 7 that are the same as or similar to portions of the apparatus 10a in FIG. 6 are given the same reference numbers with the addition of the suffix “b”.

In FIG. 7, the bag retainer 256b is secured to ends of the elongated wall portions 238b and 246b opposite the end portions 242b and 250b. Since the side panels of the air bag 222b extend over the flow openings 240b and 248b of the upper and lower closure members 232b and 234b, respectively, the side panels of the air bag 222b are formed with flow openings 266.

FIG. 7 illustrates the closure device 230b in a first position relative to the module housing 200b. When the inflator 228b is actuated and the air bag 222b inflates into the extended condition, a force acts though the side panels of the air bag 222b. The force is transferred to the bag retainer 256b and to the closure device 230b for moving the closure device from the first position relative to the module housing 200b to a second position relative to the module housing.

In the second position relative to the module housing 200b, the end portions 242b and 250b of the upper and lower closure members 232b and 234b, respectively, engage the flanges 214b and 218b of the upper and lower walls 204b and 206b of the module housing 200b. Also, in the second position, the elongated wall portions 238b and 246b of the upper and lower closure members 232b and 234b close the flow openings 212b and 216b in the upper and lower walls 204b and 206b of the module housing 200b to prevent gas flow from the chamber 220b through the flow openings. Although not shown in FIG. 7, when the closure device 230 is in the second position, the flow openings 266 in the side panels of the air bag 222b are pressed against the upper and lower walls 204b and 206b of the module housing 200b to help prevent gas flow from the chamber 220b through the flow openings 266b of the air bag 222b.

The apparatus 10c of FIG. 8 is similar to the apparatus 10b of FIG. 7. Therefore, portions of apparatus 10c in FIG. 8 that are the same as or similar to portions of apparatus 10b in FIG. 7 are identified using the same reference numbers with the addition of a prime.

In FIG. 8, the bag retainer 256b′ is secured to the upper and lower closure members 232b′ and 234b′ adjacent the flow openings 240b′ and 248b′. The side panels of the air bag 222b′ include flow openings 266′ through which fluid may flow when the closure device 230b′ is in the first position.

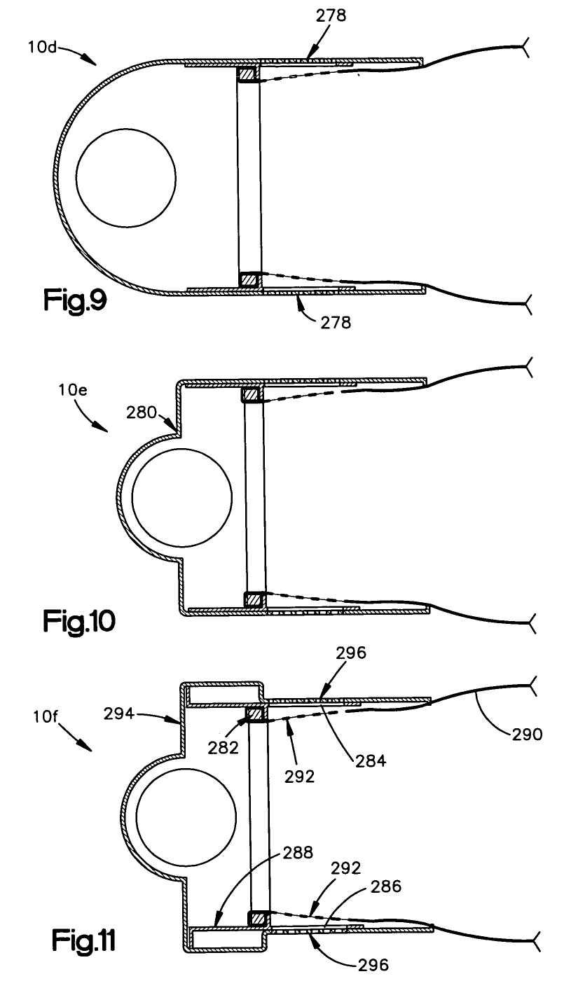

The apparatus 10d of FIG. 9 is similar to the apparatus 10c of FIG. 8 with the exception that the elongated flow openings in the upper and lower walls of the main body portion of the module housing are replaced with arrays 278 of smaller flow openings.

The apparatus 10e of FIG. 10 is similar to the apparatus 10d of FIG. 9 with the exception that the curved end portion of the main body portion of the module housing has been replaced with an end wall portion 280 similar to that shown and described with reference to the module housing 30 of FIGS. 1-5.

The apparatus 10f of FIG. 11 is similar to the apparatus 10 of FIGS. 1-5 with the exception that the bag retainer 282 is secured adjacent the flow openings 284 and 286 of the closure device 288. Since the side panels of the air bag 290 extend over the flow openings 284 and 286, the side panels of the air bag 290 include flow openings 292. Also, in FIG. 11, the flow openings of the module housing 294 are formed from arrays 296 of small flow openings.

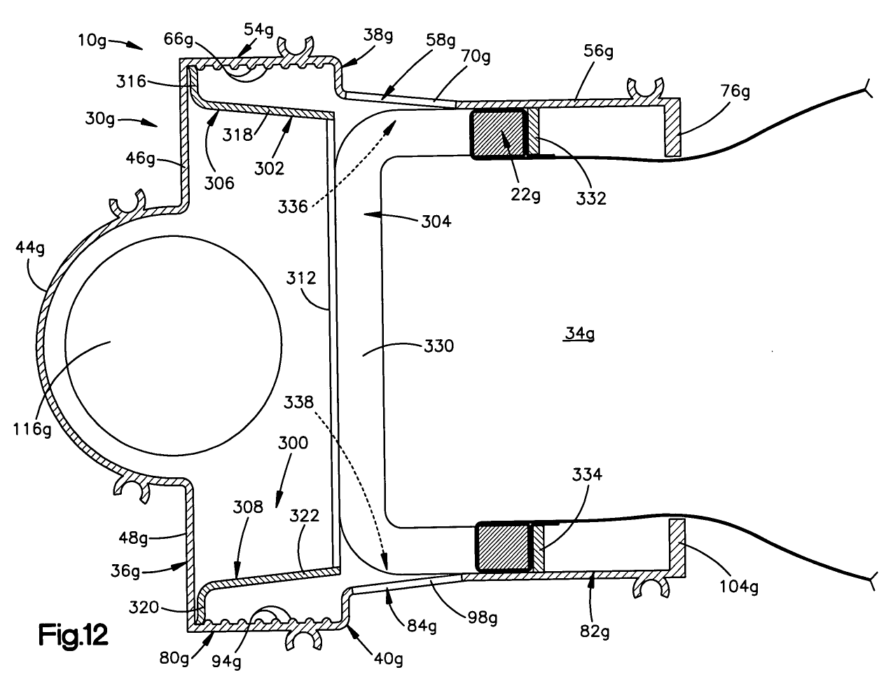

The apparatus 10g of FIG. 12 is similar to the apparatus 10 of FIGS. 1-5. Therefore, portions of apparatus 10g in FIG. 12 that are the same as or similar to portions of apparatus 10 in FIGS. 1-5 are given the same reference number with the addition of the suffix “g”.

In the apparatus 10g of FIG. 12, the closure device 300 includes a closure portion 302 and two retainer portions 304. FIG. 12 only illustrates one of the two retainer portions 304. The closure portion 302 includes upper and lower closure members 306 and 308, respectively, which are secured together with two support posts 312. Only one of the two support posts 312 is shown in FIG. 12. The upper closure member 306 includes a flange portion 316 and an elongated wall portion 318 that is sized for closing a flow opening 70g in the upper wall 38g of the module housing 30g. The lower closure member 308 includes a flange portion 320 and an elongated wall portion 322 that is sized for closing a flow opening 98g in the lower wall 40g of the module housing 30g.

Each retainer portion 304 has a C-shaped configuration that includes a base portion 330 and two leg portions 332 and 334. The base portion 330 of each retainer portion 304 is fixed to an adjacent support post 312 of the closure portion 302. The leg portions 332 and 334 of the retainer portions 304 include flanges to which the bag retainer 22g is secured.

When the bag retainer 22g is fixed to the flanges of the retainer portion 304 of the closure device 300, gas flow passages 336 and 338 are defined between the bag retainer 22g and the upper and lower closure members 306 and 308, respectively. When the closure device 330 is in the first position relative to the module housing 30g, as is shown in FIG. 12, gas may flow into or out of the chamber 34g through the gas flow passages 336 and 338 and the flow openings 70g and 98g in the upper and lower walls 38g and 40g of the module housing 30g. When the air bag 14g reaches the extended condition and the closure device 300 is moved into the second position relative to the module housing 30g, the upper and lower closure members 306 and 308 close the flow openings 70g and 98g in the upper and lower walls 38g and 40g, respectively, of the module housing 30g to prevent gas flow out of the chamber 34g through the flow openings.

From the above description of the invention, those skilled in the art will perceive improvements, changes and modifications. For example, filters may be mounted to the module housing to cover the flow openings in the housing so that any gas is filtered when flowing into or out of the module housing. Such improvements, changes and modifications within the skill of the art are intended to be covered by the appended claims.

Having described the invention, we claim the following:

1. A vehicle occupant protection apparatus comprising:
a housing including a flow opening through which fluid may flow;
an inflatable occupant protection device being inflatable from a stored condition to an inflated condition, structure of the inflatable occupant protection device defining an inflatable volume of the inflatable occupant protection device; and
a closure device being movable relative to the housing from a first position to a second position for restricting fluid flow through the flow opening,
the structure of the inflatable occupant protection device being attached to the closure device, a force results from the structure of the inflatable occupant protection device reaching a full extension during inflation from the stored condition to the inflated condition, the force acting through the structure of the inflatable occupant protection device that is attached to the closure device and moving the closure device from the first position to the second position.

2. The vehicle occupant protection apparatus of claim 1 wherein the structure of the inflatable occupant protection device includes side panels that are pulled taut when the structure reaches the full extension, the force acting through the side panels to move the closure device to the second position.

3. The vehicle occupant protection apparatus of claim 1 wherein the closure device and the housing include components that interact with one another for resisting movement of the closure device away from the first position prior to the structure of the inflatable occupant protection device reaching the full extension.

4. The vehicle occupant protection apparatus of claim 3 wherein the components include a plurality of ridges located on opposing interior surfaces of the housing and flanges of the closure device that engage the ridges.

5. The vehicle occupant protection apparatus of claim 3 wherein the force resulting from the structure of the inflatable occupant protection device reaching the full extension is greater than a resistance to movement resulting from the components of the closure device and the housing interacting with one another.

6. The vehicle occupant protection apparatus of claim 1 wherein the closure device and the housing include components for interacting with one another to stop movement of the closure device at the second position relative to the housing.

7. The vehicle occupant protection apparatus of claim 6 wherein the components include radially extending portions of the housing and end portions of the closure device that engage the radially extending portions when the closure device is in the second position relative to the housing.

8. The vehicle occupant protection apparatus of claim 7 wherein the end portions of the closure device include radially outwardly extending flanges that engage the radially extending portions of the housing when the closure device is in the second position relative to the housing.

9. The vehicle occupant protection apparatus of claim 7 wherein the radially extending portions of the housing are radially inwardly extending flanges.

10. The vehicle occupant protection apparatus of claim 1 further including a retainer to which a mouth portion of the inflatable occupant protection device is fixed, the retainer being fixed to the closure device.

11. The vehicle occupant protection apparatus of claim 1 wherein the closure device includes a flow opening and a wall portion that is located adjacent the flow opening, the flow opening of the closure device aligning with the flow opening of the housing when the closure device is in the first position and the wall portion of the closure device covering the flow opening of the housing when the closure device is in the second position.

12. The vehicle occupant protection apparatus of claim 1 wherein side panels of the vehicle occupant protection device extend over the flow opening of the housing when the closure device is in the first position, the side panels of the vehicle occupant protection device including flow openings through which fluid may flow.

13. The vehicle occupant protection apparatus of claim 1 further including an inflator that is actuatable for providing inflation fluid to the vehicle occupant protection device, air being aspirated through the flow opening of the housing to supplement the inflation fluid provided by the inflator during movement of the vehicle occupant protection device from the stored condition to the inflated condition.

14. The vehicle occupant protection apparatus of claim 1 further including an inflator that is located within the housing and is actuatable for providing inflation fluid to the vehicle occupant protection device, inflation fluid flowing out of the housing through the flow opening when the closure device is in the first position and air pressure within the housing is greater than atmospheric air pressure.
